(19) United States
(12) Patent Application Publication
(10) Pub. No.: US 2005/0213081 A1
(43) Pub. Date: Sep. 29, 2005

(54) Device and method for detecting inclination of screen, and projection apparatus

(75) Inventor: Hajime Hirahara, Saitama (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/087,638

(22) Filed: Mar. 24, 2005

(30) Foreign Application Priority Data
Mar. 25, 2004 (JP) JP 2004-089877

(51) Int. Cl. G01B 11/02

(52) U.S. Cl. 356/138

(57) ABSTRACT

A device for detecting the inclination of a screen includes a single image sensor detecting voltages in proportion to the brightness of light beams, the light beams being reflected from two positions horizontally or vertically remote from each other on the screen and being incident on the image sensor; a distance measuring section for determining the distances between the image sensor and the two respective positions on the screen from the respective voltages detected by the image sensor; and an inclination angle measuring section for determining the inclination angle of the screen from the distances determined in the distance measuring section. The inclination of the screen can be easily and correctly adjusted through the use of the device.

This application is based upon and claims the benefit of priority from the prior Japanese Patent Application No. 2004-89877 filed on Mar. 25, 2004; the entire contents of which are incorporated by reference.

### BACKGROUND OF THE INVENTION

1. Field of the Invention

The present invention relates to devices and methods for detecting the inclination of screens on which enlarged video-light beams are projected, and relates to projection apparatuses.

2. Description of the Related Art

Recently, projection apparatuses projecting enlarged video-light beams corresponding to video signals on screens have been put to practical use. When a screen is inclined with respect to the video-light beams projected from such a projection apparatus, images displayed on the screen are trapezoidally distorted or defocused. Thus, the screen must be disposed such that the screen is not inclined with respect to a projection lens that projects the video-light beams.

A method for detecting the inclination of a screen measures a distance between a position on the screen and a reference position opposing the position on the screen. The distance measurement is performed at least at two positions. The positions on the screen are, for example, located at the left end and at the right end of the screen. The reference position is, for example, located on an extension from the surface of the projection lens of the projection apparatus. The method then detects the inclination of the screen by the difference between these distances.

Since the brightness of the light is reduced in proportion to the traveling distance, the distances between the two positions on the screen and the respective reference positions can be determined with two image sensors that generate and output voltages in proportion to the brightness of the light and that are disposed in front of the two respective positions on the screen.

That is to say, this known device or method detects the inclination of the screen from the difference in voltage in proportion to the brightness of the light detected by the two image sensors.

These two image sensors must be disposed on the reference positions in front of the screen. If there is an error in position between the two image sensors, the distances are incorrectly detected. Thus, the detection of the screen inclination is relatively complicated work.

In particular, for the projection apparatus used in the house, the screen is not permanently mounted in general. Therefore, users are disadvantageously required to conduct this complicated work for setting the screen whenever they use the projection apparatus.

### BRIEF SUMMARY OF THE INVENTION

It is an object of the present invention to provide a device and a method for detecting the inclination of a screen, and a projection apparatus capable of detecting the inclination of the screen correctly and easily.

The device according to an aspect of the present invention includes a single image sensor detecting voltages according to the brightness of light beams, the light beams being reflected from two positions horizontally or vertically remote from each other on the screen and being incident on the image sensor; and an inclination-detecting circuit detecting the inclination of the screen on the basis of the voltages detected by the image sensor.

The method according to another aspect of the present invention comprising: a step for irradiating a single image sensor with light beams reflected from two positions horizontally or vertically remote from each other on the screen; and a step for detecting the inclination of the screen from the voltages detected by the single image sensor in proportion to the brightness of the light beams reflected from the two positions.

The projection apparatus according to the present invention includes a projector projecting enlarged video-light beams corresponding to video signals on a screen; a single image sensor detecting voltages in response to the light beams, the light beams being reflected from two positions horizontally or vertically remote from each other on the screen and being incident on the image sensor; and an inclination-detecting circuit detecting the inclination of the screen on the basis of the voltages detected by the image sensor.

The above and other objects, features and advantage of the invention will become more clearly understood from the following referring to the accompanying drawing.

### BRIEF DESCRIPTION OF THE DRAWINGS

FIG. 1 is a conceptual diagram illustrating the basic concept for detecting the inclination of a screen according to an embodiment of the present invention;

FIG. 2 illustrates cells of an image sensor used for detecting the inclination of the screen according to the embodiment of the present invention; and

FIG. 3 is a block diagram illustrating the structure of a projection apparatus using a device for detecting the inclination of a screen according to the embodiment of the present invention.

### DETAILED DESCRIPTION OF THE INVENTION

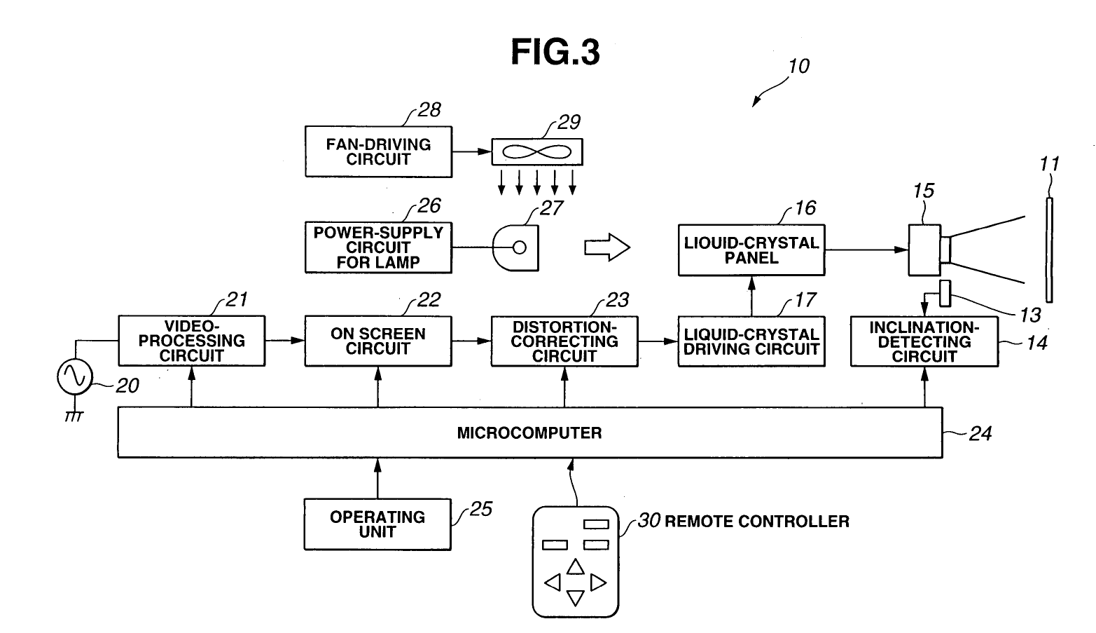

The structure of a projection apparatus using a device and a method for detecting the inclination of a screen according to an embodiment of the present invention will now be described with reference to FIG. 3.

A projector 10 includes a screen 11, a projection lens 15, a liquid-crystal panel 16, a liquid-crystal driving circuit 17, a signal source 20, a video-processing circuit 21, an onscreen circuit 22, a distortion-correcting circuit 23, a microcomputer 24, an operating unit 25, a power-supply circuit 26 for a lamp, a light-source lamp 27, a fan-driving circuit 28, a fan 29, and a remote controller 30.

The projection lens 15 enlarges and projects video-light beams on the screen 11.

The liquid-crystal panel 16 displays optical images that are to be projected from the projection lens 15 toward the screen 11.

The liquid-crystal driving circuit 17 drives the liquid-crystal panel 16 in response to video signals, and converts illumination-light beams from the light-source lamp 27 (described below) into video-light beams.

The signal source 20 includes television signals; video signals of video equipment, DVD players, or the like; information signals from personal computers, and the like.

The video-processing circuit 21 processes signals from the signal source 20 in a predetermined way to generate video signals of the video-light beams projected from the liquid-crystal panel 16 through the liquid-crystal driving circuit 17.

The onscreen circuit 22 superposes character and graphic signals on the video signals generated at the video-processing circuit 21.

The distortion-correcting circuit 23 corrects the distortion of images depending on the video signals when the images are projected and displayed on the screen. The video signals may be superposed with the character and graphic signals at the onscreen circuit 22, or may be without the character and graphic signals.

The microcomputer 24 controls the driving of the video-processing circuit 21, the onscreen circuit 22, the distortion-correcting circuit 23, and an inclination-detecting circuit 14 (described below).

The operating unit 25 and the remote controller 30 are used for issuing instructions for various operations to the projector 10. The operating unit 25 includes various switches and buttons disposed on the body of the projector 10. The remote controller 30 transmits and receives instruction signals for various operations via infrared signals at a position remote from the projector 10.

The power-supply circuit 26 lights the light-source lamp 27 to project the illumination-light beams on the liquid-crystal panel 16. The illumination-light beams projected from the light-source lamp 27 penetrate through the liquid-crystal panel 16, are enlarged by the projection lens 15, and then are projected on the screen 11.

The fan-driving circuit 28 drives the fan 29 to cool the light-source lamp 27 for dissipating heat generated when the light-source lamp 27 is lit.

The projector 10 further includes an image sensor 13 for detecting the inclination of the screen disposed adjacent to the projection lens 15, and the inclination-detecting circuit 14 for detecting the inclination of the screen 11 from voltages output from the image sensor 13.

According to the operational instructions input by users via the operating unit 25 or the remote controller 30, the projector 10 performs a predetermined signal processing on the signals from the signal source 20 at the video-processing circuit 21, superposes the character and graphic signals on the resultant signals at the onscreen circuit 22, and corrects the distortion of the resultant signals at the distortion-correcting circuit 23 to generate video signals under the control of the microcomputer 16. The liquid-crystal driving circuit 17 drives the liquid-crystal panel 16 in response to the video signals, and converts the illumination-light beams from the light-source lamp 27 into the video-light beams. The video-light beams are enlarged by the projection lens 15, and then projected on the screen 11.

As described above, when the screen 11 is inclined with respect to the projection lens 15 of the projector 10, the images projected on the screen 11 are distorted or defocused. The distortion caused by the inclination of the screen 11 is an important issue at the setting of the screen 11 since the distortion cannot be canceled by the correction at the distortion-correcting circuit 23.

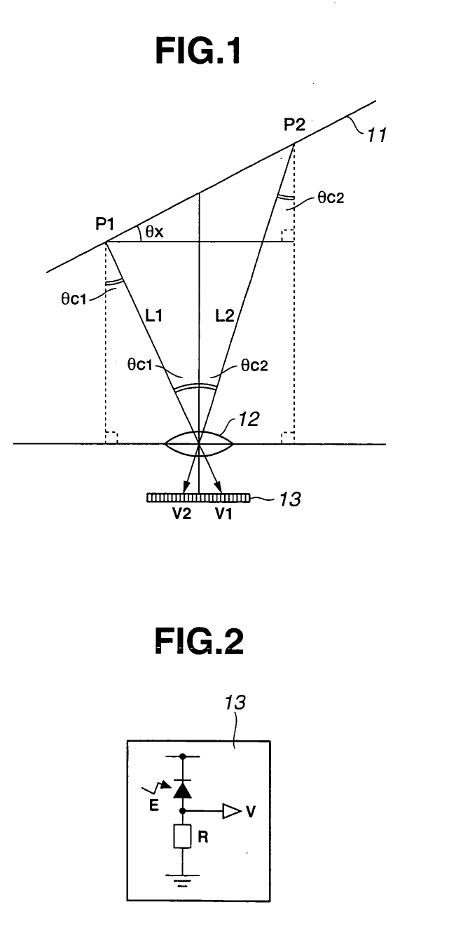

The projector 10 according to the embodiment of the present invention includes the device and the method for detecting the inclination of the screen 11 including the image sensor 13 and the inclination-detecting circuit 14 to correctly set the screen 11 with respect to the projection lens 15. The device and the method will now be described with reference to FIG. 1.

FIG. 1 is a conceptual diagram illustrating the basic concept for detecting the inclination of the screen by the device and the method according to the embodiment of the present invention.

The screen 11 is disposed so as to oppose the projection lens 15 of the projector 10. The image sensor 13 is disposed adjacent to the optical axis of the projection lens 15 such that light beams reflected from the screen 11 are incident on the image sensor 13 through a condenser 12.

The video-light beams projected from the projection lens 15 are reflected at the screen 11. The condenser 12 converges the light beams reflected from the screen 11 and the light beams are incident on the image sensor 13.

The image sensor 13 includes a plurality of cells composed of photodiodes and the like. The cells are disposed on the image sensor 13 so as to be transversely symmetrical with respect to the optical axis of the condenser 12.

As shown in FIG. 2, each cell of the image sensor 13 outputs a voltage V in proportion to the brightness E of the incident light beam.

As described above, the brightness of the light beam is reduced in proportion to the traveling distance. The voltage output from each cell of the image sensor 13 is proportional to the brightness of the light beam, and the brightness of the light beam is proportional to the distance between the screen 11 and the image sensor 13. Accordingly, a relationship between a cell voltage V of the image sensor 13 and a distance L between the screen 11 and the condenser 12 can be represented by approximate Expression 1:
V≈k/(2·L)² (1)
where k is a constant.

A light beam reflected from a position P1 adjacent to one end of the screen 11 passes through the condenser 12 and is incident on a cell located at the right side in the drawing remote from the center (the optical axis) of the image sensor 13. A cell voltage V1 at the cell on which the light beam reflected from the position P1 is incident is determined from the relationship represented by Expression 1. On the other hand, a light beam reflected from a position P2 adjacent to the other end of the screen 11 passes through the condenser 12 and is incident on a cell located at the left side in the drawing remote from the center (the optical axis) of the image sensor 13. A cell voltage V2 at the cell on which the light beam reflected from the position P2 is incident is determined from the relationship represented by Expression 1. The cell voltages V1 and V2, respectively, are given by:
V1=k/(2·L1)², V2=k/(2·L2)²
where L1 and L2 respectively indicate the distances between the positions P1 and P2 on the screen 11 and the condenser 12.

The inclination-detecting circuit 14 determines the distances L1 and L2 between the positions P1 and P2 on the screen 11 and the condenser 12 from the cell voltages V1 and V2 of the image sensor 13 by Expression 2:

$$L 1 = \sqrt{\frac{k}{4 \cdot V 1}} , L 2 = \sqrt{\frac{k}{4 \cdot V 2}} \qquad ( 2 )$$

The inclination-detecting circuit 14 then determines the inclination angle θx of the screen 11 from the distances L1 and L2 determined by Expression 2 and trigonometry by Expression 3:

$$θ x = {tan}^{- 1} \frac{L 2 \cdot sin ( 90 ° - θ c 2 ) - L 1 \cdot sin ( 90 ° - θ c 1 )}{L 1 \cdot sin θ c 1 + L 2 \cdot sin θ c 2} \qquad ( 3 )$$

where θc1 and θc2 are angles (constants) determined by the optical axis and the positions of the cells on the image sensor 13 on which the light beams reflected from the positions P1 and P2 on the screen 11 are incident.

The inclination angle θx of the screen 11 determined by Expression 3 expresses the inclination of the screen 11. The inclination of the screen 11 is adjusted such that the inclination angle θx becomes zero.

In the case for adjusting the horizontal inclination of the screen 11, the positions P1 and P2 are horizontally remote from each other with respect to the center of the screen 11 corresponding to the center of the optical axis of the condenser 12. In the case for adjusting the vertical inclination of the screen 11, the positions P1 and P2 are vertically remote from each other with respect to the center of the screen 11 corresponding to the center of the optical axis of the condenser 12.

As described above, the device and the method for detecting the inclination of the screen according to the embodiment of the present invention include the single image sensor 13 and the inclination-detecting circuit 14. The image sensor 13 outputs voltages in proportion to the brightness of the light beams reflected from at least two positions on the screen 11. The inclination-detecting circuit 14 includes a distance measuring section which determines the distance L1 between the condenser 12 and the position P1 and the distance L2 between the condenser 12 and the position P2 by Expression 2 from the respective voltages V1 and V2 detected by the image sensor 13, and an inclination angle measuring section which determines the inclination of the screen 11 by Expression 3 from the distances L1 and L2 determined in the distance measuring section.

The inclination of the screen can be easily and correctly adjusted on the basis of the inclination angle detected at the inclination-detecting circuit 14.

The device for detecting the inclination of the screen is disposed adjacent to the projection lens of the projector so as to facilitate detecting the inclination of the screen to the projector and to facilitate adjusting the inclination.

Having described the preferred embodiments of the invention referring to the accompanying drawings, it should be understood that the present invention is not limited to those precise embodiments and various changes and modifications thereof could be made by one skilled in the art without departing from the spirit or scope of the invention as defined in the appended claims.

1. A device for detecting the inclination of a screen, comprising:
a single image sensor detecting voltages according to the brightness of light beams, the light beams being reflected from two positions horizontally or vertically remote from each other on the screen and being incident on the image sensor; and
an inclination-detecting circuit detecting the inclination of the screen on the basis of the voltages detected by the image sensor.

2. The device according to claim 1, wherein the inclination-detecting circuit comprises:
a distance measuring section which determines the distances between the image sensor and the two respective positions horizontally or vertically remote from each other on the screen from the respective voltages according to the brightness of the respective reflected light beams detected by the image sensor; and
an inclination angle measuring section which determines the inclination angle of the screen from the distances between the two positions on the screen horizontally or vertically remote from each other and the image sensor determined in the distance measuring section.

3. The device according to claim 2, wherein the distance measuring section determines the distance L1 between the image sensor and one of the two positions, referred to as P1, on the screen and the distance L2 between the image sensor and the other position, referred to as P2, on the screen from the voltages, which are referred to as V1 and V2, detected by the image sensor by the following expression, the voltages V1 and V2 being detected in proportion to the brightness of light beams reflected from the two positions P1 and P2 on the screen:
$$L 1 = \sqrt{\frac{k}{4 \cdot V 1}} , L 2 = \sqrt{\frac{k}{4 \cdot V 2}}$$
where k is a constant.

4. The device according to claim 2, wherein the inclination angle measuring section determines the inclination angle θx of the screen from the distances L1 and L2 determined in the distance measuring section by the following expression:
$$θ x = {tan}^{- 1} \frac{L 2 \cdot sin ( 90 ° - θ c 2 ) - L 1 \cdot sin ( 90 ° - θ c 1 )}{L 1 \cdot sin θ c 1 + L 2 \cdot sin θ c 2}$$
where θc1 and θc2 are constant angles defined by the center of the optical axis of the image sensor and the two respective positions P1 and P2 horizontally or vertically remote from each other on the screen.

5. The device according to claim 1, wherein the image sensor is disposed in the center of the optical axis of the light beams reflected from the screen.

6. A method for detecting the inclination of a screen, comprising:
a step for irradiating a single image sensor with light beams reflected from two positions horizontally or vertically remote from each other on the screen; and
a step for detecting the inclination of the screen from the voltages detected by the single image sensor in proportion to the brightness of the light beams reflected from the two remote positions on the screen.

7. The method according to claim 6, wherein the distance L1 between the image sensor and one of the two positions, referred to as P1, on the screen and the distance L2 between the image sensor and the other position, referred to as P2, on the screen are determined by the following expression from the voltages, which are referred to as V1 and V2, detected by the image sensor, the voltages V1 and V2 being detected according to the brightness of light beams reflected from the two positions P1 and P2 on the screen:
$$L 1 = \sqrt{\frac{k}{4 \cdot V 1}} , L 2 = \sqrt{\frac{k}{4 \cdot V 2}}$$
where k is a constant; and
an inclination angle Ox of the screen is determined by the following expression from the distances L1 and L2:
$$θ x = {tan}^{- 1} \frac{L 2 \cdot sin ( 90 ° - θ c 2 ) - L 1 \cdot sin ( 90 ° - θ c 1 )}{L 1 \cdot sin θ c 1 + L 2 \cdot sin θ c 2}$$
where θc1 and θc2 are constant angles defined by the center of the optical axis of the image sensor and the two respective positions P1 and P2 horizontally or vertically remote from each other on the screen.

8. A projection apparatus comprising:
a projector projecting enlarged video-light beams depending on video signals on a screen;
a single image sensor detecting voltages according to the light beams, the light beams being reflected from two positions horizontally or vertically remote from each other on the screen to which the video-light beams are projected from the projector and being incident on the image sensor; and
an inclination-detecting circuit detecting the inclination of the screen on the basis of the respective voltages in proportion to the reflected light beams detected by the image sensor.

9. The projection apparatus according to claim 8, wherein
the inclination-detecting circuit comprises:
a distance measuring section for determining the distances between the image sensor and the two respective positions on the screen horizontally or vertically remote from each other from the respective voltages detected by the image sensor; and
an inclination angle measuring section for determining the inclination angle of the screen from the distances between the image sensor and the two respective positions on the screen horizontally or vertically remote from each other, the distances being determined in the distance measuring section.

10. The projection apparatus according to claim 9, wherein
the distance measuring section determines the distance L1 between the image sensor and one of the two positions, referred to as P1, on the screen and the distance L2 between the image sensor and the other position, referred to as P2, on the screen from the voltages, which are referred to as V1 and V2, detected by the image sensor by the following expression, the voltages V1 and V2 being detected according to the brightness of light beams reflected from the two positions P1 and P2 on the screen:
$$L 1 = \sqrt{\frac{k}{4 \cdot V 1}} , L 2 = \sqrt{\frac{k}{4 \cdot V 2}}$$
where k is a constant.

11. The projection apparatus according to claim 9, wherein
the inclination angle measuring section determines the inclination angle Ox of the screen from the distances L1 and L2 determined in the distance measuring section by the following expression:
$$θ x = {tan}^{- 1} \frac{L 2 \cdot sin ( 90 ° - θ c 2 ) - L 1 \cdot sin ( 90 ° - θ c 1 )}{L 1 \cdot sin θ c 1 + L 2 \cdot sin θ c 2}$$
where θc1 and θc2 are constant angles defined by the center of the optical axis of the image sensor and the two respective positions P1 and P2 horizontally or vertically remote from each other on the screen.

12. The projection apparatus according to claim 8, wherein
the image sensor is disposed adjacent to the projection lens and the optical axis of the projection lens of the projector.
